(19) United States
(12) Patent Application Publication
(10) Pub. No.: US 2011/0303640 A1
(43) Pub. Date: Dec. 15, 2011

(54) NANOIMPRINT METHOD

(75) Inventors: ZHEN-DONG ZHU, Beijing (CN); QUN-QING LI, Beijing (CN); LI-HUI ZHANG, Beijing (CN); MO CHEN, Beijing (CN); YUAN-HAO JIN, Beijing (CN)

(73) Assignees: HON HAI PRECISION INDUSTRY CO., LTD., Tu-Cheng (TW); TSINGHUA UNIVERSITY, Beijing (CN)

(21) Appl. No.: 12/979,309

(22) Filed: Dec. 27, 2010

(30) Foreign Application Priority Data
Jun. 14, 2010 (CN) 201010200766.6

(51) Int. Cl. C03C 25/68; B29C 59/02; B82Y 40/00

(52) U.S. Cl. 216/54; 264/293; 977/887

(57) ABSTRACT

A nanoimprint method is provided. A substrate and a master stamp are first provided. The substrate has a first resist layer, a transition layer, and a second resist layer orderly formed thereon. The master stamp has a nanopattern defined therein. The second resist layer is a layer of hydrogen silsesquioxane. The nanopattern of the master stamp is then pressed into the second resist layer to form a nanopattern in the second resist layer at normal temperature which is in a range from about 20 centidegrees to about 50 centidegrees. Finally, the nanopattern of the second resist layer is transferred to the substrate.

### RELATED APPLICATIONS

This application claims all benefits accruing under 35 U.S.C. §119 from China Patent Application No. 201010200766.6, filed on Jun. 14, 2010 in the China Intellectual Property Office, the disclosure of which is incorporated herein by reference.

### BACKGROUND

1. Technical Field

This disclosure relates to nanoimprint methods and, particularly, to a nanoimprint method, of which a pressing process can be carried out at normal temperature.

2. Description of Related Art

In fabrication of semiconductor integrated electrical circuits, integrated optical, magnetic, mechanical circuits and micro devices, and the like, a key processing method is lithography. Lithography creates a pattern in a thin film located on a substrate, so that in subsequent process steps, the pattern will be replicated in the substrate or in another material located on the substrate. Since the role of the thin film is to protect a part of the substrate in the subsequent replication steps, the thin film is called a resist.

Nanoimprint lithography (NIL) is a method of fabricating nanometer scale patterns. It is a simple nanolithography process with low cost, high throughput, and high resolution. It creates patterns by mechanical deformation of an imprint resist through a mole and subsequent processes. The imprint resist is typically a monomer or polymer formulation that is cured by heat or UV light during the imprinting.

However, a pressing process of a typical nanoimprint lithography is usually carried out at a high temperature which will unduly increase the adhesiveness between the imprint resist and the mole. As a result, distortions and deformations of the resident imprinting nanostructures will occur when the mold is removed away from the imprint resist.

### BRIEF DESCRIPTION OF THE DRAWINGS

Many aspects of the embodiments can be better understood with references to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1A through 1G are sectional views of one embodiment of a nanoimprint method.

FIG. 2A through 2G are sectional views of another embodiment of a nanoimprint method.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

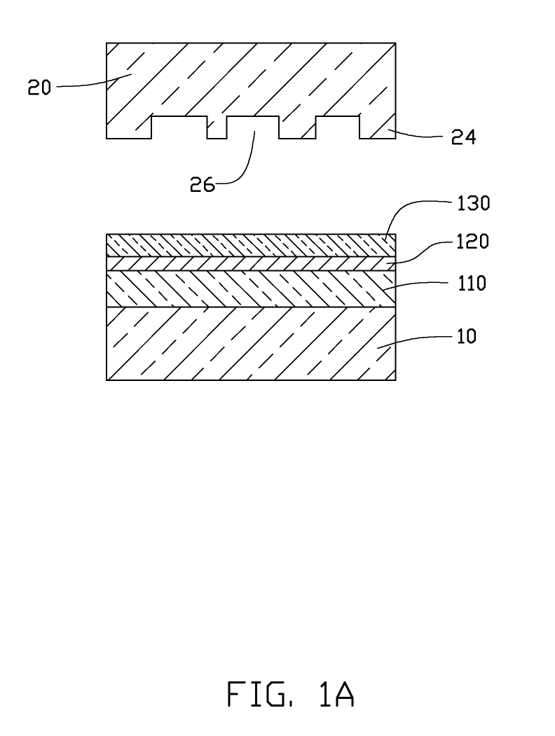

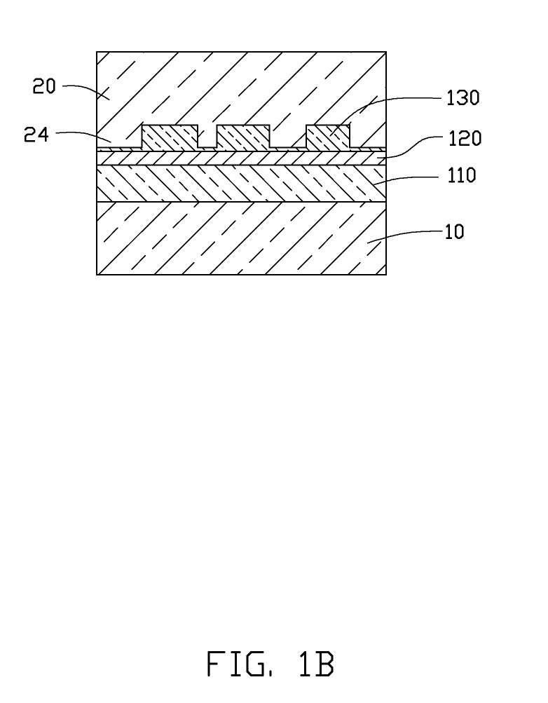

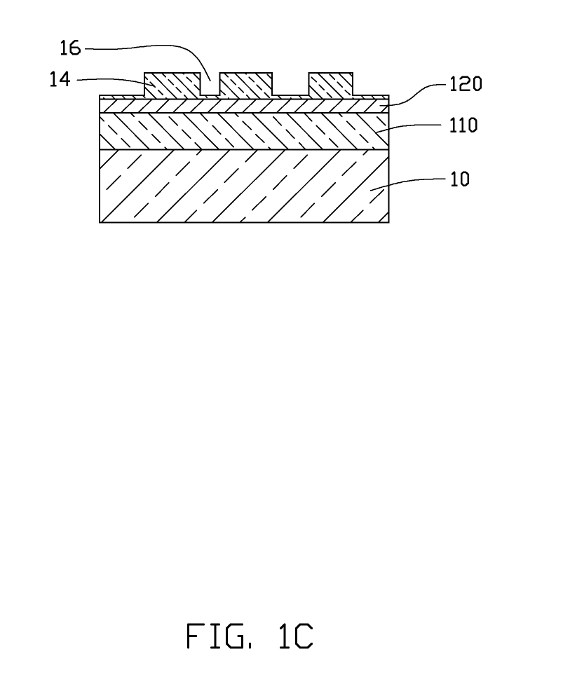

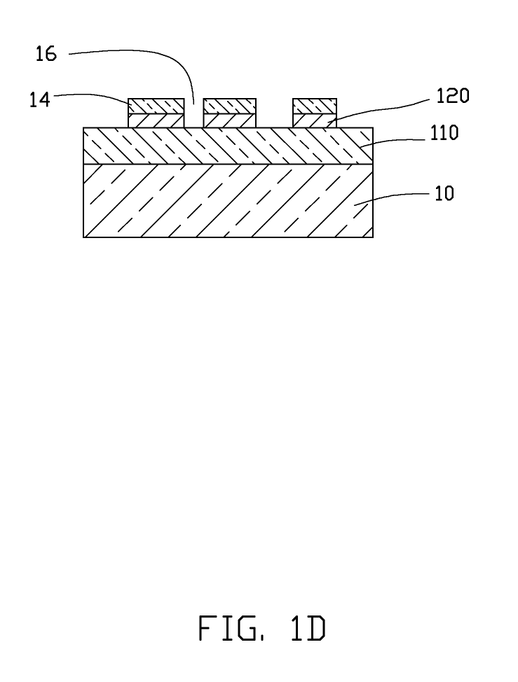

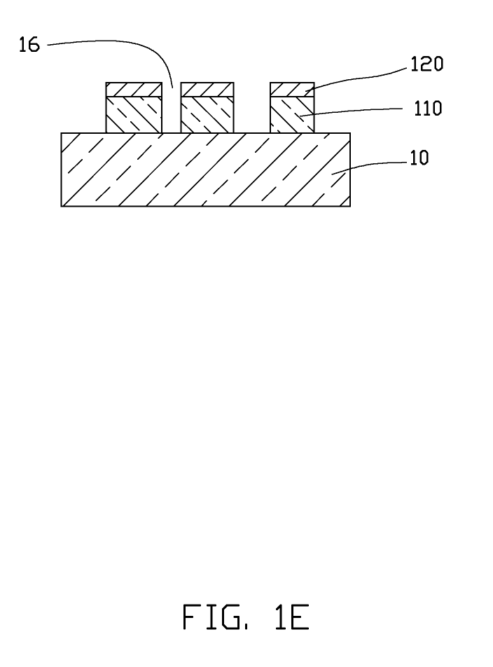

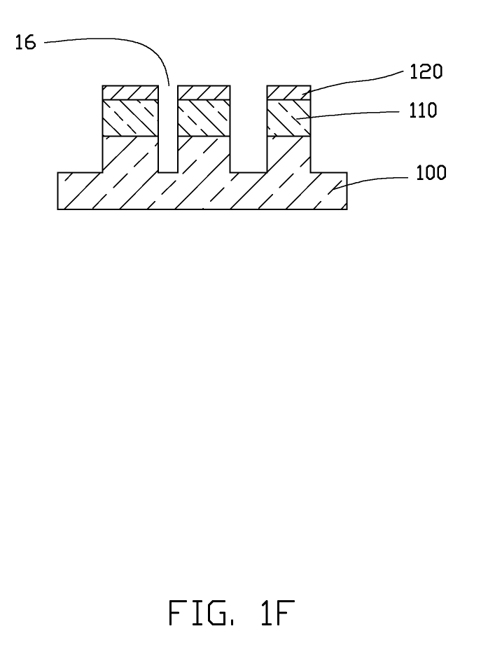

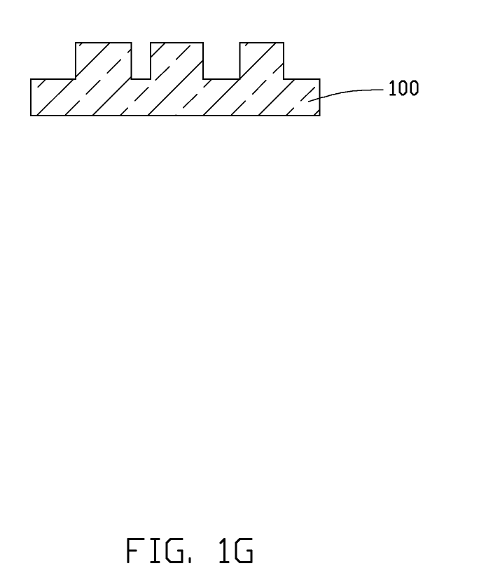

Referring to FIGS. 1A to 1G, one embodiment of a nanoimprint method includes:

(a) providing a substrate 10 and a master stamp 20, the substrate 10 having a first resist layer 110, a transition layer 120, and a second resist layer 130 orderly formed thereon, and the master stamp 20 having a nanopattern defined therein;

(b) pressing the nanopattern of the master stamp 20 into the second resist layer 130 to form a nanopattern in the second resist layer 130; and

(c) transferring the nanopattern of the second resist layer 130 to the substrate 10.

Step (a) includes sub-steps of:

(a1) forming the first resist layer 110 on a top surface of the substrate 10;

(a2) forming the transition layer 120 on a top surface of the first resist layer 110, so that the first resist layer 110 is between the transition layer 120 and the substrate 10;

(a3) forming the second resist layer 130 on a top surface of the transition layer 120, so that the transition layer 120 is between the second resist layer 130 and the first resist layer 110.

In step (a1), the substrate 10 is first cleaned, and then coated with a layer of organic resist. Finally, the layer of organic resist is dried. The substrate 10 can be made of rigid materials, such as silicon, silicon-dioxide, silicon nitride, and gallium nitride. The substrate 10 can also be made of flexible materials, such as polystyryl pyridine (PSP), polymethyl methacrylate (PMMA), and polyethylene terephthalate (PET).

In one embodiment, the substrate 10 can be made of silicon. The substrate 10 can be cleaned in a clean room, and then a layer of positive electron-beam resist can be spin-coated on the substrate 10 at a speed of about 500 rounds per minute to about 6000 rounds per minute, for about 0.5 minutes to about 1.5 minutes. The positive electron-beam resist can be ZEP520 resist, which is developed by Zeon Corp of Japan. Finally, the substrate 10 with the positive electron-beam resist can be dried at a temperature of about 140 degrees centigrade to 180 degrees centigrade, for about 3 minutes to about 5 minutes. Thereby, the first resist layer 110 is formed on the substrate 10. The thickness of the first resist layer 110 can be in a range of about 100 nanometers to about 500 nanometers.

In step (a2), the transition layer 120 can be made of silicon dioxide. The transition layer 120 can be coated on the first resist layer 100 through a sputtering method or a deposition method. In one embodiment, the transition layer 120 can be a glassy silicon dioxide film with a thickness of about 10 nanometers to about 100 nanometers.

In step (a3), the second resist layer 130 can be a layer of hydrogen silsesquioxane (HSQ), which can be deposited on the transition layer 120 through a bead coating method or a spin-coating method. In one embodiment, the HSQ can be spin-coated on the transition layer 120 under high pressure at a speed of about 2500 rounds per minute to about 7000 rounds per minute, for about 0.5 minutes to about 2 minutes. The thickness of the second resist layer 130 can be in a range of about 100 nanometers to about 300 nanometers.

The thickness of the second resist layer 130 plays an important role in the pressing process of step (b). After the HSQ is solidified, the HSQ is similar to carbon dioxide. If the thickness of the second resist layer 130 is too thick, it will increase the difficulties of etching and removing the second resist layer 130 in subsequent processes. If the thickness of the second resist layer 130 is too thin, it cannot provide a high enough etching selectivity in the subsequent processes.

Further, the HSQ can be pressed to be deformed at normal temperature in a range from about 20 centidegrees to about 50 centidegrees, thus step (b) can be carried out at normal temperature. Moreover, the HSQ has good structural stability, and provides a high resolution better than 10 nm.

In step (b), the master stamp 20 can be made of rigid materials, such as nickel, silicon, and carbon dioxide. The master stamp 20 can also be made of flexible materials, such as PET, PMMA, polystyrene (PS), and polydimethylsiloxane (PDMS). The master stamp 20 can be fabricated through an electron beam lithography method with the nanopattern formed therein. The nanopattern can be designed according to the actual application. In one embodiment shown in FIG. 1A, the nanopattern can include a plurality of first ribs 24 and a plurality of first grooves 26.

In step (b), the master stamp 20 is first placed on the second resist layer 130 with the nanopattern contacting the second resist layer 130. The master stamp 20 is then pressed towards the second resist layer 130 at normal temperature. During this process, the first ribs 24 are pressed into the second resist layer 130, and some materials of the second resist layer 130 are pressed into the first grooves 26. Finally, the master stamp 20 is removed from the second resist layer 130 with the nanopattern remaining in the second resist layer 130. The nanopattern of the second resist layer 130 includes a plurality of second ribs 14 and a plurality of second grooves 16. The second ribs 14 correspond to the first grooves 26. The second grooves 16 correspond to the first ribs 24.

In one embodiment, the master stamp 20 is pressed towards the second resist layer 130 at normal temperature in a vacuum environment of about 1×10⁻¹ millibars to about 1×10⁻⁵ millibars. The pressure applied on the master stamp 20 is about 2 pounds per square foot to about 100 pounds per square foot. The pressure is applied on the master stamp 20 for about 2 minutes to about 30 minutes. It is easy to be understood that there may be remaining material of the second resist layer 130 at the bottom of the second grooves 16 after step (b).

Step (c) includes sub-steps of:

(c1) removing the remaining material of the second resist layer 130 at the bottom of the second grooves 16 to expose the transition layer 120 in part;

(c2) etching the transition layer 120 exposed by the second grooves 16 to expose the first resist layer 110 in part;

(c3) etching the first resist layer 110 exposed by the second grooves 16 to expose the substrate 10 in part; and

(c4) etching the substrate 10 exposed by the second grooves 16 and removing the first resist layer 110 away from the substrate 10.

In step (c1) and step (c2), the remaining material of the second resist layer 130 at the bottom of the second grooves 16 and the transition layer 120 exposed by the second grooves 16 can be removed by plasma etching.

In one embodiment, a CF₄ reactive plasma etching method can be used to remove the remaining material of the second resist layer 130 at the bottom of the second grooves 16 and the transition layer 120 exposed by the second grooves 16. For example, the substrate 10 with the second ribs 14 and the second grooves 16 formed thereon can be placed in a CF₄ reactive plasma etching system. Then, the CF₄ reactive plasma etching system generates CF₄ plasma, and the CF₄ plasma moves towards the second resist layer 130 to etch away the remaining material of the second resist layer 130 at the bottom of the second grooves 16 and the transition layer 120 exposed by the second grooves 16.

The power of the CF₄ reactive plasma etching system can be in a range of about 10 watts to about 150 watts. The speed of the CF₄ plasma can be about 2 standard-sate cubic centimeter per minute (sccm) to about 100 sccm. The partial pressure of the CF₄ plasma can be about 1 pascal (Pa) to about 15 Pa. The etching time can be about 2 seconds to about 4 minutes.

In step (c3), the first resist layer 110 exposed by the second grooves 16 can be removed by oxygen plasma etching. For example, the substrate 10 after being treated by step (c2) can be placed in an oxygen plasma etching system. The power of the oxygen plasma etching system can in a range of about 10 watts to about 150 watts. The speed of the oxygen plasma can be about 2 sccm to about 100 sccm. The partial pressure of the oxygen plasma can be about 0.5 Pa to about 15 Pa. The etching time can be about 5 seconds to about 1 minute. During the process of etching the first resist layer 110, a cross linking reaction will occur in the second ribs 14 in the presence of oxygen plasma, so that the second ribs 14 and the transition layer 120 together function as a mask, to ensure the resolution of the first resist layer 110.

In step (c4), the substrate 10 after being treated by step (c3) can be placed in an inductively coupled plasma device, with a mixture of silicon tetrachloride and chlorine, to etch the substrate 10 exposed by the second grooves 16. The power of the inductively coupled plasma device can be about 100 watts, the speed of the chlorine is about 20 sccm to about 60 sccm, and the speed of the silicon tetrachloride is about 20 sccm to about 60 sccm. The partial pressure of the silicon tetrachloride and chlorine is about 4 Pa to about 15 Pa. Further, referring to FIG. 1F, the residue of the first resist layer 110 can be washed away through organic solvents such as acetone, and thus the residue of the transition layer 120 located on the residue of the first resist layer 110 can also be removed. As a result, a base 100 having the same nanopattern as that of the master stamp 20 can be obtained.

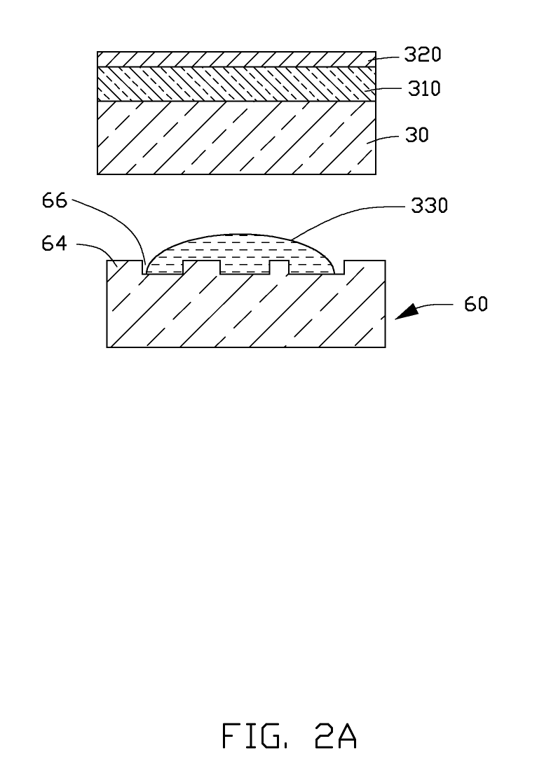

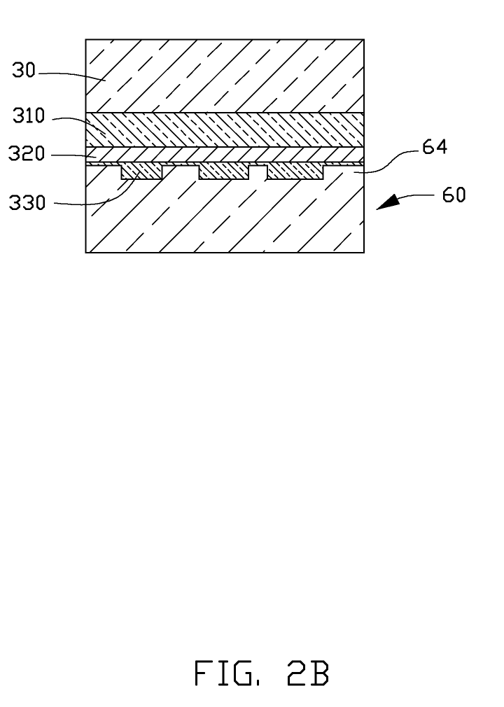

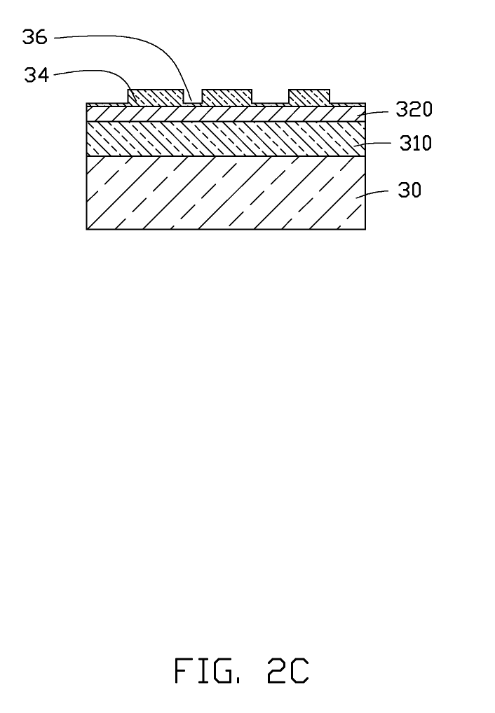

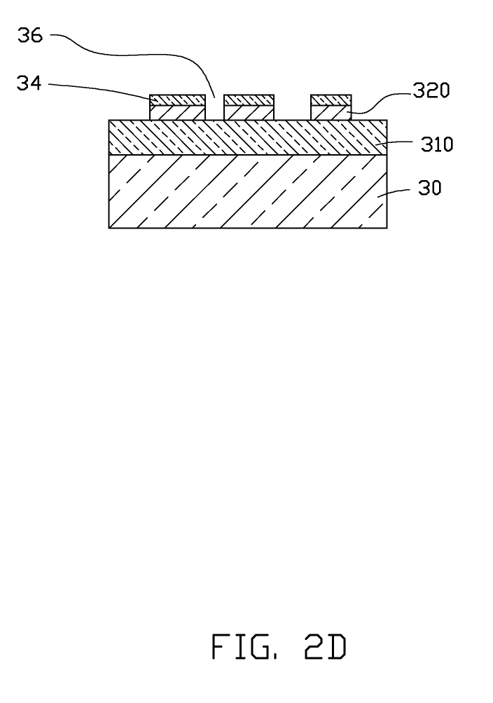

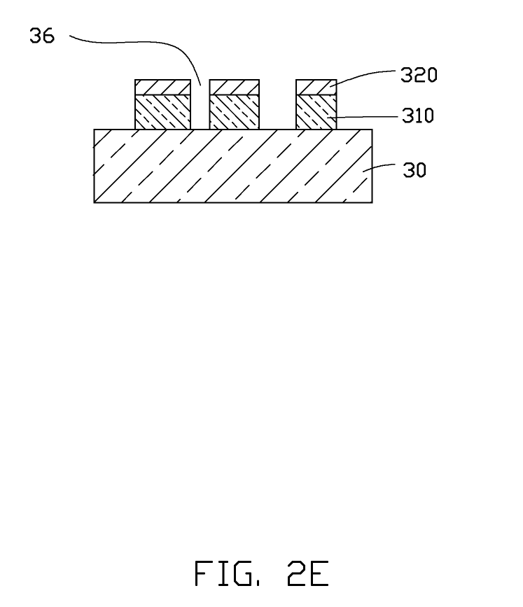

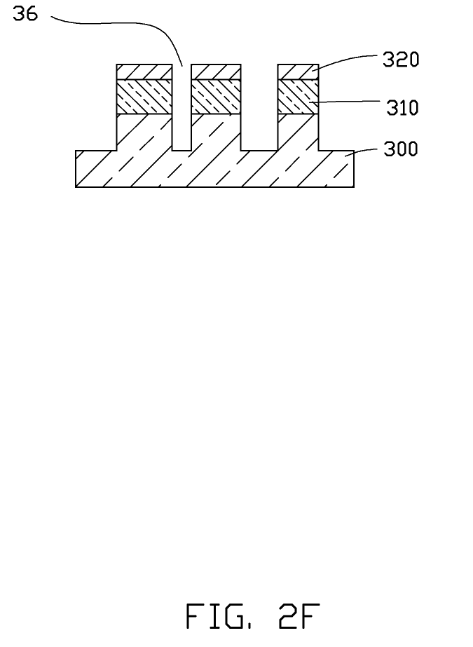

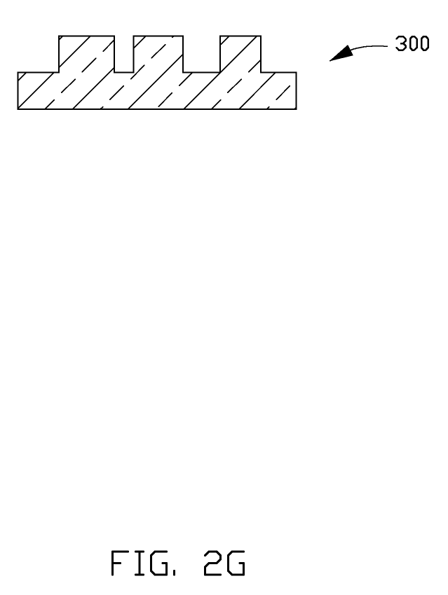

Referring to FIGS. 2A to 2G, another embodiment of a nanoimprint method includes:

(A) providing a substrate 30 and a master stamp 60, the substrate 30 having a first resist layer 310 and a transition layer 320 orderly formed thereon, the master stamp 60 having a nanopattern defined therein, and a second resist layer 330 disposed on the nanopattern;

(B) placing the substrate 30 on the master stamp 60 with the transition layer 320 contacting the second resist layer 330, and pressing the substrate 30 and the master stamp 60 towards each other at normal temperature to transfer the second resist layer 330 on the transition layer 320 in the form of a nanopattern; and

(C) transferring the nanopattern of the second resist layer 130 to the substrate 30.

In step (A), the substrate 30 and the master stamp 60 have similar structures with that of the substrate 10 and the master stamp 20, respectively, except that the second resist layer 330 is disposed on the nanopattern of the master stamp 60. The nanopattern of the master stamp 60 also includes a plurality of first ribs 64 and a plurality of first grooves 66. In one embodiment, the second resist layer 330 can be made of HSQ. The HSQ can be deposited on the nanopattern of the master stamp 60 through a bead coating method, and then stand for about 1 hour to about 2 hours in a sealed environment.

In step (B), the substrate 30 is first placed on the master stamp 60 with the transition layer 320 contacting the second resist layer 330. The substrate 30 and the master stamp 60 are placed in a stamping machine which provides a vacuum environment of about 1×10⁻¹ millibars to about 1×10⁻⁵ millibars. The stamping machine applies a pressure of about 2 pounds per square foot to about 100 pounds per square foot on the master stamp 60, for about 2 minutes to about 30 minutes. As a result, the material of the second resist layer 330 is filled in the first grooves 66 and adhered on the transition layer 320 to form the nanopattern of the second resist layer 330 on the transition layer 320. The nanopattern of the second resist layer 330 includes a plurality of second ribs 34 and a plurality of second grooves 36.

Step (C) can be similar to step (C) of the embodiment shown in FIGS. 1A to 1G, then a base 300 having the same nanopattern as that of the master stamp 60 can be obtained.

Depending on the embodiment, certain of the steps of methods described may be removed, others may be added, and the sequence of steps may be altered. It is also to be understood that the above description and the claims drawn to a method may include some indication in reference to certain steps. However, the indication used is only to be viewed for identification purposes and not as a suggestion as to an order for the steps.

Finally, it is to be understood that the above-described embodiments are intended to illustrate rather than limit the disclosure. Variations may be made to the embodiments without departing from the spirit of the disclosure as claimed. The above-described embodiments illustrate the scope of the disclosure but do not restrict the scope of the disclosure.

What is claimed is:

1. A nanoimprint method comprising:
(a) providing a substrate and a master stamp, the substrate having a first resist layer, a transition layer, and a second resist layer orderly formed thereon, the master stamp having a nanopattern defined therein and the second resist layer being a layer of hydrogen silsesquioxane;
(b) pressing the nanopattern of the master stamp into the second resist layer to form a nanopattern in the second resist layer at a normal temperature which is in a range from about 20 centidegrees to about 50 centidegrees;
(c) transferring the nanopattern of the second resist layer to the substrate.

2. The nanoimprint method of claim 1, wherein step (b) comprises substeps of:
(b1) placing the substrate and the master stamp in a stamping machine, which provides a vacuum environment of about 1×10⁻¹ millibars to about 1×10⁻⁵ millibars;
(b2) applying a pressure of about 2 pounds per square foot to about 100 pounds per square foot on the master stamp at the normal temperature through the stamping machine, for about 2 minutes to about 30 minutes; and
(b3) separating the master stamp from the substrate.

3. The nanoimprint method of claim 2, wherein step (a) comprises substeps of:
(a1) forming the first resist layer on a surface of the substrate;
(a2) forming the transition layer on a surface of the first resist layer, so that the first resist layer is between the transition layer and the substrate;
(a3) forming the second resist layer on a surface of the transition layer, so that the transition layer is between the second resist layer and the first resist layer.

4. The nanoimprint method of claim 3, wherein step (a1) comprises: (a11) cleaning the substrate; (a12) coating a layer of organic resist on the substrate; and (a13) drying the layer of organic resist.

5. The nanoimprint method of claim 4, wherein step (a12) comprises spin-coating the layer of organic resist on the substrate at a speed of about 500 rounds per minute to about 6000 rounds per minute, for about 0.5 minutes to about 1.5 minutes.

6. The nanoimprint method of claim 4, wherein step (a13) comprises drying the layer of organic resist at a temperature of about 140 degrees centigrade to 180 degrees centigrade, for about 3 minutes to about 5 minutes.

7. The nanoimprint method of claim 3, wherein step (a3) comprises spin-coating the second resist layer on the transition layer under high pressure at a speed of about 2500 rounds per minute to about 7000 rounds per minute, for about 0.5 minutes to about 2 minutes.

8. The nanoimprint method of claim 7, wherein in step (a3), the second resist layer has a thickness in a range of about 100 nanometers to about 300 nanometers.

9. The nanoimprint method of claim 1, wherein in step (b), the nanopattern in the second resist layer comprises a plurality of grooves and a plurality of ribs; step (c) comprises substeps of:
(c1) removing remaining material of the second resist layer in the grooves to expose the transition layer in part;
(c2) etching the transition layer exposed by the grooves to expose the first resist layer in part;
(c3) etching the first resist layer exposed by the grooves to expose the substrate in part; and
(c4) etching the substrate exposed by the grooves and removing the first resist layer away from the substrate.

10. The nanoimprint method of claim 9, wherein step (c1) and step (c2) are carried out in a same process, which comprises: placing the substrate in a CF4 reactive plasma etching system; and etching away the remaining material of the second resist layer in the grooves and the transition layer exposed by the grooves through CF4 plasma generated by the CF4 reactive plasma etching system.

11. The nanoimprint method of claim 9, wherein step (c3) comprises placing the substrate in an oxygen plasma etching system, and etching the first resist layer exposed by the grooves through oxygen plasma generated by the oxygen plasma etching system.

12. The nanoimprint method of claim 9, wherein step (c4) comprises washing the substrate and the first resist layer through an organic solvent to remove the first resist layer away from the substrate.

13. The nanoimprint method of claim 12, wherein the organic solvent comprises acetone.

14. A nanoimprint method comprising:
(a) providing a substrate and a master stamp, the substrate having a first resist layer and a transition layer orderly formed thereon, the master stamp having a nanopattern defined therein and a second resist layer disposed on the nanopattern, the second resist layer being a layer of hydrogen silsesquioxane;
(b) placing the substrate on the master stamp with the transition layer contacting the second resist layer, and pressing the substrate and the master stamp towards each other at normal temperature which is in a range from about 20 centidegrees to about 50 centidegrees to transfer the second resist layer on the transition layer in a nanopattern form; and
(c) transferring the nanopattern of the second resist layer to the substrate.

15. The nanoimprint method of claim 14, wherein step (b) comprises substeps of:
(b1) placing the substrate and the master stamp in a stamping machine which provides a vacuum environment of about 1×10⁻¹ millibars to about 1×10⁻⁵ millibars;
(b2) applying a pressure of about 2 pounds per square foot to about 100 pounds per square foot on the master stamp at the normal temperature through the stamping machine, for about 2 minutes to about 30 minutes;
(b3) seperating the master stamp from the substrate.

16. The nanoimprint method of claim 14, wherein step (a) comprises substeps of:
dripping material of the second resist layer in the nanopattern of the master stamp;
and standing in a sealed environment for about 1 hour to about 2 hours.
